(19) United States
(12) Patent Application Publication
(10) Pub. No.: US 2026/0158711 A1
(43) Pub. Date: Jun. 11, 2026

(54) MOLDING APPARATUS, MOLDING APPARATUS CONTROL METHOD, MANUFACTURING SYSTEM, PRODUCT MANUFACTURING METHOD USING MOLDING APPARATUS, AND RECORDING MEDIUM

(71) Applicant: CANON KABUSHIKI KAISHA, Tokyo (JP)

(72) Inventors: TAKUJI OISHI, Kanagawa (JP); JUNNOSUKE NAKAMURA, Tochigi (JP)

(21) Appl. No.: 19/399,233

(22) Filed: Nov. 24, 2025

(30) Foreign Application Priority Data
Dec. 10, 2024 (JP) 2024-215059

(51) Int. Cl. B29C 43/36; B29C 43/58

(52) U.S. Cl. CPC B29C 43/361; B29C 43/58; B29C 2043/3636; B29C 2043/5808; B29C 2043/5816; B29C 2043/585

(57) ABSTRACT

A molding apparatus that manufactures a molded product by bringing molds into pressure contact, the molding apparatus includes a probe configured to transmit and receive an acoustic signal, wherein the probe is disposed at a plurality of positions different from each other in a radial direction between an outer edge and a center of molding surfaces of the molds.

### BACKGROUND

### Field of the Technology

The present disclosure relates to a molding apparatus.

### Description of the Related Art

Mold press forming apparatuses are known for manufacturing optical elements, such as lenses by press molding a molding material, such as glass, softened by heating between molding surfaces of a pair of molds that have been precisely machined into a predetermined shape. In a molding process, such as a transfer process in which the molding surfaces of the molds are pressed against the molding material, such as glass softened by heating, to deform the molding material while allowing the molding material to conform to the molding surfaces of the molds, it is desirable that the molding material is caused to conform to the molding surfaces of the molds without any untransferred portions over a desired area.

In the transfer process, if the molding material is not sufficiently stretched to cover the desired area, and if untransferred portions occur at the peripheral portion, the molded optical element may become smaller than a predetermined size, which can result in a molding defect.

In order to conform the molding material to the molding surfaces of the molds over the desired area without any untransferred portions, for example, Japanese Patent Laid-Open No. 2011-256087 describes a molding apparatus that improves transferability by applying ultrasonic waves to the mold to cause vibration. Further, Japanese Patent Laid-Open No. 2012-41213 describes a molding apparatus that improves the transferability by a configuration in which a high-temperature region on the molding surfaces of the molds is gradually expanded from the center toward the outer diameter side of the molding surfaces.

However, in recent years, the surface accuracy required for optical elements has become considerably high, and in some cases, it may be necessary to reproduce not only the range in which the molding material ultimately conforms to the molding surfaces of the molds, but also the transfer progress in molding as the molding material conforms to the molding surfaces of the molds. However, the configurations described in Japanese Patent Laid-Open No. 2011-256087 and Japanese Patent Laid-Open No. 2012-41213 cannot measure the transfer progress in molding as the molding material conforms to the molding surfaces of the molds. Thus, it is difficult to guarantee the reproducibility of the molding surfaces.

Further, when an untransferred portion occurs for any reason, in the configurations described in Japanese Patent Laid-Open No. 2011-256087 and Japanese Patent Laid-Open No. 2012-41213, it is impossible to detect the occurrence of the untransferred portion until the molding process is completed, the molds are opened, and the molded optical element is removed.

### SUMMARY

In view of the above-described issue, the present disclosure is directed to providing a mold press type molding apparatus capable of monitoring a transfer progress in molding as a molding material conforms to a molding surface of a mold, during the molding.

A molding apparatus that manufactures a molded product by bringing molds into pressure contact, the molding apparatus includes a probe configured to transmit and receive an acoustic signal, wherein the probe is disposed at a plurality of positions different from each other in a radial direction between an outer edge and a center of molding surfaces of the molds.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view illustrating a molding apparatus before pressing.

FIG. 2 is a sectional view illustrating the molding apparatus during pressing.

FIGS. 3A and 3B are diagrams illustrating ultrasonic wave propagation in a through-transmission mode, FIG. 3A illustrating ultrasonic wave propagation in a state in which an upper mold is not in contact with glass, and FIG. 3B illustrating a state in which the upper mold is in contact with the glass. FIGS. 3C and 3D are diagrams illustrating ultrasonic wave propagation in a pulse-echo mode, FIG. 3C illustrating ultrasonic wave propagation in a state in which an upper mold is not in contact with the glass, and FIG. 3D illustrating ultrasonic wave propagation in a state in which the upper mold is in contact with the glass.

FIGS. 4A to 4D are waveform diagrams illustrating received ultrasonic waveforms.

FIGS. 5A to 5C are diagrams illustrating different positional relationships between the glass and ultrasonic wave paths.

FIG. 6 is a sectional view illustrating ultrasonic wave propagation in the upper mold, the glass, and a lower mold.

FIG. 7 is a sectional view illustrating an example of an arrangement pattern of a waveguide rod.

FIG. 8 is a sectional view illustrating an example of an arrangement pattern of a probe.

FIG. 9 is a block diagram illustrating a configuration example of a control system for performing display control based on a contact state between the molds and the glass.

FIGS. 10A and 10B are waveform diagrams illustrating transfer progress acquired by the configuration in FIG. 9, and FIGS. 10C and 10D are waveform diagrams illustrating transfer progress acquired by a configuration illustrated in FIG. 11.

FIG. 11 is a block diagram illustrating a configuration example of a control system for controlling the contact state between the molds and the glass.

FIG. 12 is a flowchart illustrating a control procedure performed by the control system illustrated in FIG. 9.

FIG. 13 is a flowchart illustrating a control procedure performed by the control system illustrated in FIG. 11 for controlling molding based on the contact state between the molds and the glass.

### DESCRIPTION OF THE EMBODIMENTS

Hereinafter, embodiments of the present disclosure will be described with reference to the drawings. In the following embodiments, the contact state between molds and molding material, such as glass, can be observed or measured based on a phenomenon in which propagation of acoustic signals, in particular, ultrasonic waves, changes depending on presence or absence of a gap on a propagation path. Based on the measured contact state between the molds and the molding material, the quality of the molded product can be detected, and the glass molding can be controlled.

Hereinafter, as a molding apparatus, a mold press forming apparatus that performs molding by pressing molds into contact will be described. According to the present embodiment, acoustic signals are used to detect the contact state between the molds and molding material. Thus, acoustic signal transmission/reception devices, for example, ultrasonic transmission/reception devices, are provided as probes. Hereinafter, the same or equivalent members are denoted by the same reference characters in the drawings, and the redundant description will be omitted.

[Configuration of Molding Apparatus]

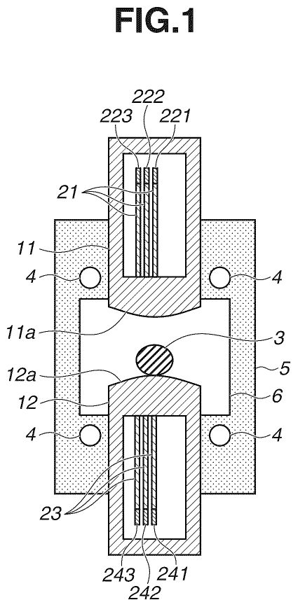

The molding apparatus according to the present embodiment is a mold press forming apparatus including a pair of molds: an upper mold 11 and a lower mold 12, that are pressed against molding material such as glass, to shape the molding material. FIG. 1 is a diagram illustrating a state in which the pair of molds (the upper mold 11 and the lower mold 12) for shaping the molding material is open.

In FIG. 1, a through hole extending vertically through a body mold 5 is formed in a central axis direction of the body mold 5. The upper mold 11 and the lower mold 12 are slidably fitted with the upper portion of the through hole and the lower portion of the through hole, respectively, along the vertical direction.

The upper mold 11 and the lower mold 12 can be made of material, such as cemented carbide, silicon carbide (SiC), or glassy carbon. Molding surfaces 11a and 12a for transferring a desired optical functional surface to glass 3, which is the molding material, are formed on the lower surface of the upper mold 11 and the upper surface of the lower mold 12, respectively.

In the present embodiment, probes 221, 222, and 223 are disposed in the upper portion of the upper mold 11, which is on the opposite side of the molding surface 11a as viewed from the glass 3, and serve as acoustic signal transmission units for detecting a contact state between the glass 3, which is the molding material, and the molds. The probes 221 to 223 may be configured by an ultrasonic transducer for use in a device, such as a pulser receiver, or a device capable of transmitting and receiving ultrasonic waves, such as a piezoelectric element. A plurality of waveguide rods 21 are disposed to propagate the ultrasonic waves generated by the probes 221 to 223 to the upper mold 11, and further to the glass 3. While the detailed arrangement will be described below, similar probes 241, 242, and 243 and waveguide rods 23 are also disposed in the lower mold 12.

The opposite side of the molding surface 11a and the opposite side of the molding surface 12a where the probes 221 to 223 and the probes 241 to 243 are disposed are heated to temperatures ranging from 500° C. to 800° C. during the molding operation. Thus, the heat resistance of the probes 221 to 223 and the probes 241 to 243 formed as normal ultrasonic wave generation units, such as ultrasonic transducers, may be insufficient. For this reason, the waveguide rods 21 and 23 are arranged to allow the probes 221 to 223 and the probes 241 to 243 to be placed away from the high temperature regions. The waveguide rods 21 and 23 may be made of material, such as sapphire, alumina, stainless steel, or the like.

As will be described below, when ultrasonic waves propagate through the waveguide rods 21 and 23 while undergoing multiple reflections, a signal that is measured as noise may be generated. Therefore, for the purpose of reducing the multiple reflections, it is desirable that each of the waveguide rods 21 and 23 be provided with a deformed portion, such as a tapered portion or a notch, and that side surfaces of the waveguide rods 21 and 23 be non-parallel. However, depending on their designs, the side surfaces of the waveguide rods 21 and 23 may be formed to be parallel to each other. The shape of the waveguide rods 21 and 23 is not limited to a cylindrical shape. The shape may be a polygonal column.

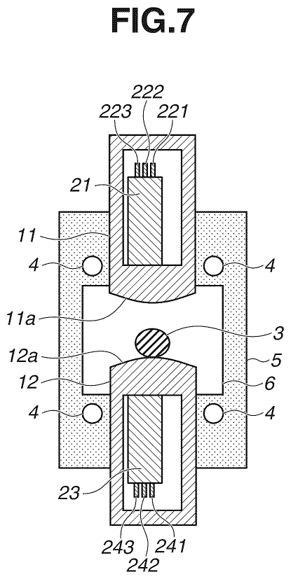

It is desirable that the thickness of each of the waveguide rods 21 and 23 be equal to or greater than the effective diameter of each of the probes 221 to 223 and the probes 241 to 243, since with this thickness, the signal-to-noise (SN) ratio of the ultrasonic signal is improved. However, depending on their design, the thickness may be equal to or smaller than the effective diameter of each of the probes 221 to 223 and the probes 241 to 243. To improve the measurement resolution of the contact position, it is desirable that one waveguide rod 21 or 23 be disposed for each probe. However, as illustrated in FIG. 7, one waveguide rod 21 may be disposed for the plurality of probes 221 to 223, and one waveguide rod 23 may be disposed for the plurality of probes 241 to 243. One waveguide rod may be shared by any plural number of probes among the probes 221 to 223 and the probes 241 to 243.

### [Molding Method]

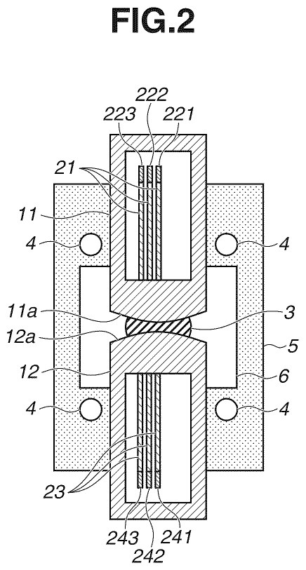

An outline of a molding operation will be described with reference to FIG. 1, which illustrates a state in which the upper mold 11 and the lower mold 12 are open, and FIG. 2, which illustrates a state in which the upper mold 11 and the lower mold 12 are closed. In the molding operation, first, the glass 3 is placed on the lower mold 12. It is desirable that the glass 3 be placed at the same position on the lower mold 12 as accurately as possible by using a robotic hand or the like. The air in a cavity 6 is replaced with inert gas such as nitrogen gas.

Heaters 4 embedded in the body mold 5 heat the glass 3 to a temperature equal to or higher than the glass-transition point, to soften the glass 3. After the glass 3 is softened, the upper mold 11 and the lower mold 12 are brought closer to each other from both sides to press the glass 3, by using a press driving mechanism (not illustrated) using a motor, a solenoid, etc. Since the glass 3 is already softened, the shapes of the molding surfaces 11a and 12a are transferred onto the glass 3, as illustrated in FIG. 2.

Next, the upper mold 11 and the lower mold 12 are moved to their predetermined positions (for example, the positions illustrated in FIG. 1) and cooled. The cooled glass 3 can be released from the molding surfaces 11a and 12a and removed by utilizing the difference in shrinkage ratio between the glass and the molds.

### [Contact State Detection Using Ultrasonic Waves]

Hereinafter, the state of an acoustic signal that is used for detecting the contact state between the pair of the upper mold 11 and the lower mold 12 and the glass 3 will be described. In particular, an operation using an ultrasonic wave as an acoustic signal will be described.

It is desirable that the intensity of an ultrasonic wave generated by each of the probes 221 to 223 and the probes 241 to 243 be set to a value at which the ultrasonic wave cannot propagate through the upper mold 11, the lower mold 12, and the glass 3 when the upper mold 11 and the lower mold 12 are not in contact with the glass 3, and the ultrasonic wave can propagate through the upper mold 11, the lower mold 12, and the glass 3 when the upper mold 11 and the lower mold 12 are in contact with the glass 3. By utilizing such signal intensity setting or characteristics, the contact state between the pair of the upper mold 11 and the lower mold 12 and the glass 3 can be determined. As for the ultrasonic wave operation mode, it is desirable to perform measurement in a through-transmission mode, in which an ultrasonic wave is transmitted from a probe in one mold (11) and is received by a probe in the other mold (12). As will be described below, the measurement can also be performed in a pulse-echo mode, in which transmission and reception of an ultrasonic wave are performed by the same probe.

Hereinafter, the operation of the ultrasonic waves, the arrangement of the probes, and the transmission and reception method of the ultrasonic waves will be described separately for the through-transmission mode and the pulse-echo mode.

### [Through-Transmission Mode]

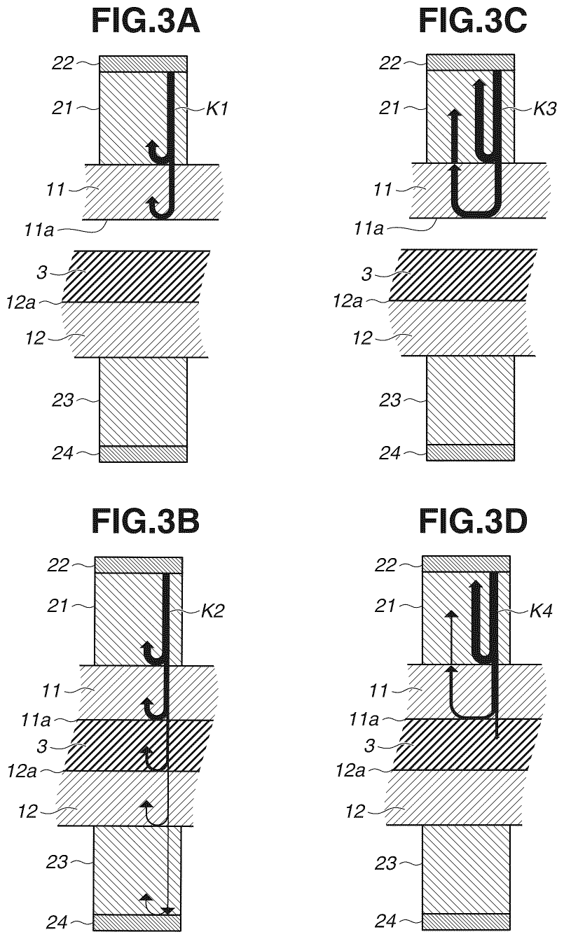

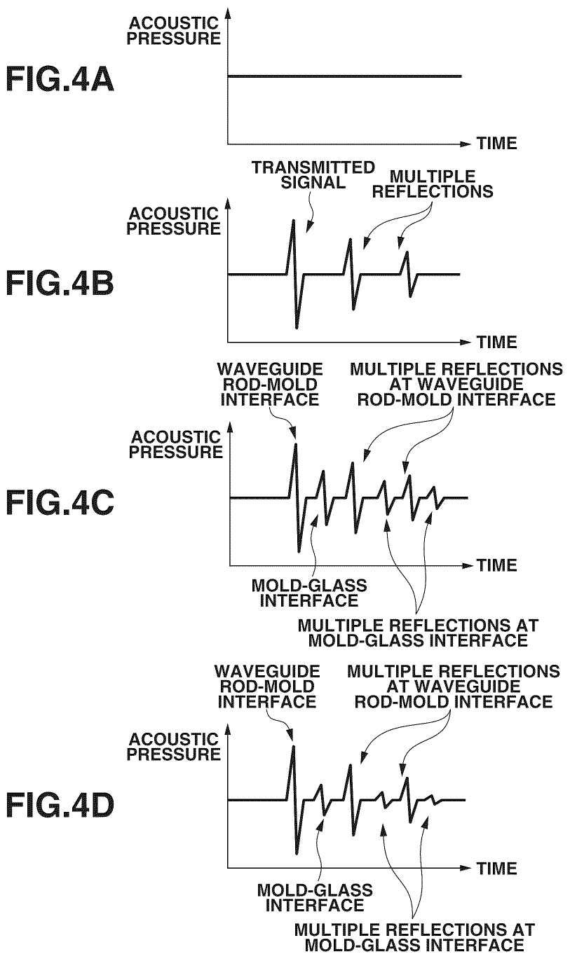

First, an operation performed in the through-transmission mode will be described with reference to FIGS. 3A, 3B, 4A, and 4B. Since the molding apparatus according to the present embodiment includes the upper mold 11 and the lower mold 12 arranged to face each other, the through-transmission mode, in which ultrasonic waves are transmitted from one mold and received by the opposing mold, can be used.

As illustrated as a path K1 in FIG. 3A, in a case where the upper mold 11 and the glass 3 are not in contact with each other, when an ultrasonic wave is transmitted from a probe 22 disposed in the upper mold 11, almost all the ultrasonic wave are reflected at the interface of a gap between the upper mold 11 and the glass 3. In this case, since a probe 24 disposed to face the probe 22 cannot receive any transmitted signal, a waveform as illustrated in FIG. 4A is detected via the probe 24. On the other hand, as illustrated as a path K2 in FIG. 3B, in a case where the upper mold 11 and the glass 3 are in contact with each other, although the ultrasonic wave is partially reflected at each interface, the ultrasonic wave can transmit and propagate to the probe 24. As a result, a signal can be received via the probe 24, and a waveform as illustrated in FIG. 4B is detected.

Since multiple reflections of the ultrasonic wave occur at the material interfaces and the side surface of a waveguide rod 21, the probe 24 may also detect multiple reflection signals following the transmitted signal. The interval between multiple reflections varies depending on the interval between the interfaces, the thickness of the waveguide rod 21, and the sound speed of the constituent material. However, in the detection in the through-transmission mode, when the detection is performed by focusing on the first transmitted signal, since a large signal difference caused by the contact or non-contact state between the mold and the glass 3 can be observed, the contact or non-contact state can be accurately and easily determined.

In the through-transmission mode, it is difficult to detect which of the upper molding surface 11a and the lower molding surface 12a comes into contact with the glass 3. When it is necessary to identify which one of the upper molding surface 11a and lower molding surface 12a is the contact surface, the propagation in the pulse-echo mode, which will be described below, may be used.

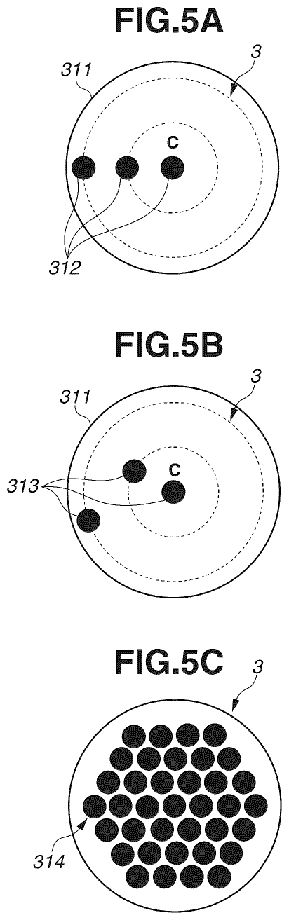

Next, the portions of the glass 3 through which the ultrasonic waves propagate will be described. FIGS. 5A to 5C are diagrams illustrating regions through which the ultrasonic waves received by the glass 3 pass through the surface of the molded glass 3.

That is, ultrasonic wave paths 312, 313, and 314 represented by black circles in FIGS. 5A, 5B, and 5C, respectively, correspond to the propagation paths of ultrasonic waves, and have different arrangements. FIG. 5A illustrates the ultrasonic wave paths 312, which are three ultrasonic wave paths aligned in a straight line along the diameter (radius) of the glass 3 from a center point C toward the outer edge, that is, an outer periphery 311. The arrangement of the ultrasonic wave paths 313 in FIG. 5B will be described below. FIG. 5C illustrates the arrangement of the ultrasonic wave paths 314, which are a large number of ultrasonic wave paths arranged so as to fill the outer shape of the glass 3. In FIG. 5C, the large number of ultrasonic wave paths 314 are arranged in an approximately hexagonal region.

Here, the outer diameter of the glass 3 illustrated in FIGS. 5A to 5C corresponds to the smaller one of the diameters of the upper and lower contact surfaces in a state where the pressing is completed and the glass 3 has its maximum diameter. The maximum diameter of the glass 3 slightly changes in each molding in practice. Therefore, in the present embodiment, for example, a design value is used as the maximum diameter of the glass 3 for determining the positions of the ultrasonic wave paths 312, 313, and 314 through which the ultrasonic waves propagate in the glass 3.

In particular, the ultrasonic wave paths 312, 313, and 314 are the regions where the ultrasonic waves pass through the surface of the molded glass 3. When the ultrasonic waves are refracted, the positions of the ultrasonic wave paths 312, 313, and 314 may differ between the upper and lower molding surfaces. In this case, the ultrasonic wave paths 312, 313, and 314 are arranged such that the positions of the ultrasonic wave paths 312, 313, and 314 satisfy predetermined conditions on both the upper and lower molding surfaces. The positional relationships between the ultrasonic wave paths 312, 313, and 314 and their respective probes will be described below. In the glass 3, the ultrasonic wave paths 312, 313, and 314 may partially overlap each other. However, it is desirable that the centroids of the paths be set not to overlap each other. With the above arrangements, the start of the contact, the end of the contact, and a contact timing at intermediate positions can be measured. Thus, details of the contact state can be monitored.

As illustrated in FIG. 5B, the ultrasonic wave paths 313 may be arranged by shifting their phases from each other in the circumferential direction of the glass 3. With the arrangement in FIG. 5B, even when the transfer progress of the mold pressing is not concentric progress, and even when the progress differs depending on the phase, the contact state between the mold and the glass 3 can be easily monitored. As illustrated in FIG. 5C, the arrangement in which more than three ultrasonic wave paths are set to cover the entire contact interface of the glass 3 is advantageous in that details of the contact state can be monitored even when the transfer progress is particularly complicated within the molding surface.

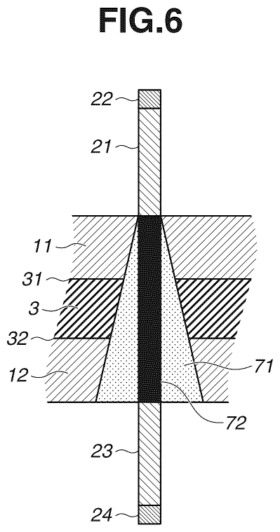

Next, the positional relationship between an ultrasonic wave path and a probe (ultrasonic probe) will be described. In general, a probe, such as an ultrasonic transducer and a piezoelectric element, may have directional characteristics. For example, an ultrasonic wave transmitted from a certain probe propagates most strongly in the normal direction of the transmission/reception surface of the probe. However, the ultrasonic wave also propagates in oblique directions. Therefore, as illustrated in FIG. 6, when an ultrasonic wave is transmitted from the probe 22, the ultrasonic wave propagates while spreading out along the traveling direction as indicated by a transmission ultrasonic wave propagation region 71. While a component of the ultrasonic wave, which is incident obliquely on an interface, is refracted due to the difference in the sound speed of the material, the refracted component is not illustrated in FIG. 6.

As described above, while the ultrasonic waves propagate while spread divergently, the ultrasonic waves which are not input to the receiving probe 24, are not measured. Therefore, as indicated by an ultrasonic wave passage region 72 in FIG. 6, it is sufficient to consider only the behavior of the ultrasonic wave within a region formed by connecting the widths of the transmitting probe 22 and the receiving probe 24 along the propagation path.

The position where the ultrasonic wave passage region 72 intersects glass surfaces 31 and 32 corresponds to the ultrasonic wave paths 312, 313, and 314 illustrated in FIGS. 5A to 5C. As described above, one ultrasonic wave passage region 72 (FIG. 6) can be defined for a pair of transmitting and receiving probes.

When each interface located between the probe 22 or 24, which outputs or inputs an ultrasonic wave, and the glass surface is perpendicular to the propagation direction of the ultrasonic wave, no refraction occurs at the interface. Thus, the ultrasonic wave path (72) matches the position of each probe, for example, the position being in the radial direction of the glass 3. On the other hand, when an interface is oblique to the propagation direction of the ultrasonic wave, the propagation path of the ultrasonic wave is refracted. Consequently, the ultrasonic wave reception path does not match the position of the probe in the radial direction. In this case, the position of the probe in the radial direction may be determined by correcting the refraction-induced displacement such that a desired ultrasonic wave reception path is obtained. The refraction-induced displacement may be obtained by simulation or geometric calculation.

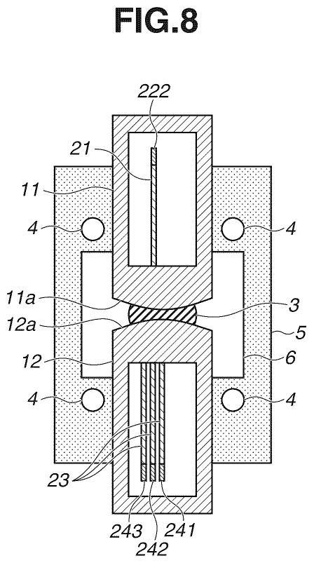

Next, the arrangement of the probes that transmit and receive ultrasonic waves will be described. For example, to set three ultrasonic wave paths, as illustrated in FIG. 8, three or more probes are disposed in one of the upper mold 11 and the lower mold 12, and one or more probes are disposed in the other mold. In the configuration illustrated in FIG. 8, three or more ultrasonic wave paths are set by a combination of one probe 222 on the ultrasonic wave transmitting side and three probes 241 to 243 on the ultrasonic wave receiving side.

As illustrated in FIG. 2, a pair of probes that transmits and receives ultrasonic waves may be arranged to form a single ultrasonic wave reception path. In FIG. 2, one ultrasonic wave path is set by the transmitting probe 221 and the receiving probe 241. Similarly, another ultrasonic wave path is set by the transmitting probe 222 and the receiving probe 242, and yet another ultrasonic wave path is set by the transmitting probe 223 and the receiving probe 243.

Further, by using the same arrangement of the probes, nine ultrasonic wave paths can be set by combining three probes for transmitting ultrasonic waves and three probes for receiving the ultrasonic waves. It is desirable that the interface between the probe and the waveguide rod, and the interface between the waveguide rod and the mold be parallel to the transmission/reception surface of the probe. With this configuration, each interface is perpendicular to the propagation direction of the ultrasonic waves, eliminating the need to consider refraction, and the probes can be easily arranged. However, when refraction of the ultrasonic waves needs to be taken into account, the probes can be arranged such that desired ultrasonic wave paths are set. Thus, the interface between the probe and the waveguide rod, and the interface between the waveguide rod and the mold may be non-parallel to the transmission/reception surface of the probe. FIGS. 1, 2, 7, and 8 illustrate merely examples, and the present disclosure is not limited to the specific configurations illustrated in these drawings.

The transmission and reception timings at which probes transmit and receive ultrasonic waves will be described. The ultrasonic waves can be repeatedly transmitted and received during molding, and a change in the contact state at a portion corresponding to an ultrasonic wave path can be observed by monitoring a change in its corresponding signal. In this way, the transfer progress can be monitored. In a case where a plurality of transmitting probes is used for performing a single transmission and reception operation, these probes may transmit ultrasonic waves at different timings such that the ultrasonic waves will not be transmitted simultaneously.

If the plurality of probes simultaneously transmits the ultrasonic waves, the receiving probe receives a signal in which the plurality of transmitted ultrasonic waves has been combined. Thus, depending on the frequency of the ultrasonic wave to be used or the position of the probe, it may be impossible to identify from which transmitting probe the signal originates. Further, in the case of simultaneous transmission, it may be difficult to identify an ultrasonic wave path corresponding to a detection signal.

However, as long as the transmitted signal can be identified from the received signal and the ultrasonic wave path can be specified, a plurality of probes may simultaneously transmit the ultrasonic waves. In this case, it is possible to control the frequencies or waveforms of the ultrasonic waves transmitted from each of the probes such that these frequencies or waveforms differ from one another. When the ultrasonic wave paths, which are the propagation paths, can be identified by performing, for example, image reconstruction in which delay adjustment and addition of each probe are performed by using a phased array technique or the like, a plurality of probes may simultaneously transmit the ultrasonic waves. As will be described below, when the user wishes to detect a deviation from a reference state instead of monitoring details of the contact state, a plurality of probes may simultaneously transmit the ultrasonic waves because it is not necessary to identify the ultrasonic wave reception paths. In a single transmission and reception operation, if there is one transmitting probe that operates, it is desirable that a plurality of receiving probes simultaneously receive the ultrasonic wave in view of detection accuracy.

### [Pulse-Echo Mode]

Next, an ultrasonic wave propagation operation in the pulse-echo mode will be described with reference to FIGS. 3C, 3D, 4C, and 4D. In the pulse-echo mode, the same probe is used for transmitting and receiving ultrasonic waves. When the probe 22 for transmitting and receiving ultrasonic waves, which is disposed in the upper mold 11, transmits an ultrasonic wave, the ultrasonic wave is reflected at the interface between the waveguide rod 21 and the upper mold 11, and the ultrasonic wave, which has transmitted through this interface, reaches the gap between the upper mold 11 and the glass 3, as indicated by a path K3 in FIG. 3C. When the upper mold 11 and the glass 3 are not in contact with each other, almost all the ultrasonic waves are reflected by the gap and are returned to the probe 22 (K3), as illustrated in FIG. 3C.

In this case, a waveform as illustrated in FIG. 4C is detected. The detected waveform indicates that, first, a signal reflected at the interface between the waveguide rod 21 and the upper mold 11 is detected, and subsequently, a signal generated by multiple reflections of the signal inside the waveguide rod 21 is detected with a delay. A signal reflected at the interface between the upper mold 11 and the glass 3 is detected later than the signal reflected at the interface between the waveguide rod 21 and the upper mold 11. This detection timing may be close to the detection timing of the multiple reflection signal reflected at the interface between the waveguide rod 21 and the upper mold 11. When two ultrasonic waves overlap each other in this manner, it becomes difficult to clearly discriminate the signal reflected at the interface between the mold and the glass from the multiple reflection signal. The overlapping of the signals can be avoided by, for example, adjusting the designs of the upper mold 11 and the waveguide rod 21, the frequency of the ultrasonic wave to be used.

When the upper mold 11 and the glass 3 are in contact with each other, part of the ultrasonic wave is transmitted into the glass 3, and another part of the ultrasonic wave returns to the probe 22, as indicated by a path K4 in FIG. 3D. The ultrasonic signal returning to the probe 22 is weaker than that in the case where the upper mold 11 and the glass 3 are not in contact with each other (FIG. 3C). When a material having a high acoustic impedance, such as cemented carbide is used for the upper mold 11 and the lower mold 12, a difference in reflection ratio is not large between the case in which the molds and the glass 3 are in the contact state and the case in which the molds and the glass 3 are in the non-contact state. As illustrated in FIG. 4D, the detection intensity of the signal reflected at the interface between the mold and the glass 3 indicates a smaller change than that in the non-contact state illustrated in FIG. 4C. Therefore, in the measurement in the pulse-echo mode, it is desirable that the designs of the interfaces and the waveguide rod 21 be adjusted such that determination of whether the molds (11, 12) and the glass 3 are in the contact state or the non-contact state can be easily performed.

As described above, in the measurement in the pulse-echo mode, by using a probe for transmitting and receiving ultrasonic waves, it becomes possible to determine from which interface a detected waveform has been obtained, based on the arrival time of the detected waveform. In this way, it is also possible to separately determine whether the glass 3 is in a contact state or non-contact state with the molding surface 11a of the upper mold 11 or the molding surface 12a or the lower mold 12.

Hereinafter, the positions of the paths of the ultrasonic waves transmitted to and received from the glass 3 in the pulse-echo mode will be described. In the pulse-echo mode, the ultrasonic wave paths 312 to 314 illustrated in FIGS. 5A to 5C correspond to regions on the molding surface where the ultrasonic waves are transmitted and reflected. In the pulse-echo mode, since the contact states of the upper and lower molding surfaces can be separately monitored, the positions of the ultrasonic wave paths 312 to 314 on the glass 3 can be separately set for the upper surface and the lower surface of the glass 3. First, as in the through-transmission mode, in the pulse-echo mode, the ultrasonic wave paths 312 can be set at least at three positions different from each other in the radial direction between the outer edge and the center of the glass 3, as illustrated in FIG. 5A.

As illustrated in FIG. 5B, the ultrasonic wave paths 313 may be arranged by shifting their phases from each other in the circumferential direction. As illustrated in FIG. 5C, in the case of the pulse-echo mode, a large number of ultrasonic wave paths 314 can be arranged so as to cover the entire contact interface of the glass 3.

The positional relationships between the ultrasonic wave paths and the probes can be determined by factoring in the reflection at the interface between the mold and the glass based on the through-transmission mode. For example, an ultrasonic wave transmitted from a probe passes through the waveguide rod 21, and reaches the interface between the upper mold 11 and the glass 3. The ultrasonic wave is reflected at the interface, and returns to the probe 22 via the waveguide rod 21. The path along which the ultrasonic wave travels is calculated factoring in refraction and reflection. In this way, the positional relationship between the ultrasonic wave path and the probe 22 can be determined.

Even in the case of the pulse-echo mode, the same concept as that of the through-transmission mode may be used for the arrangement of the probes. The probes can be arranged such that the ultrasonic wave paths are set at predetermined positions. In the pulse-echo mode, since one ultrasonic wave path is set by one probe, three probes need to be arranged to form three ultrasonic wave paths.

As for the transmission and reception timings of the ultrasonic waves, as in the through-transmission mode, it is desirable that a plurality of probes transmit and receive the ultrasonic waves at different timings. However, if an ultrasonic wave path can be identified from a received detected waveform, the plurality of probes may simultaneously transmit the ultrasonic waves.

As described above, even when the pulse-echo mode is used, the arrangement of the ultrasonic wave paths is approximately the same as that in the through-transmission mode. For example, even when the pulse-echo mode is used, the ultrasonic wave paths can be disposed at three or more positions different from each other in the radial direction between the outer edge and the center, based on the detection target positions on the molding surface. By using the pulse-echo mode, the molding apparatus can monitor the transfer progress in molding as the glass 3 conforms to the molding surfaces of the molds, during the molding, based on the arrangement positions of the probes.

### [Method of Use of Contact State: For Example, Alarm Display]

Hereinafter, two embodiments of a configuration and a control procedure using a transfer progress state detected by repeatedly transmitting and receiving ultrasonic waves in the transmission or pulse-echo mode will be described.

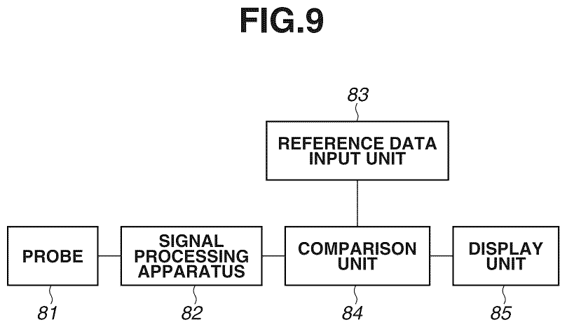

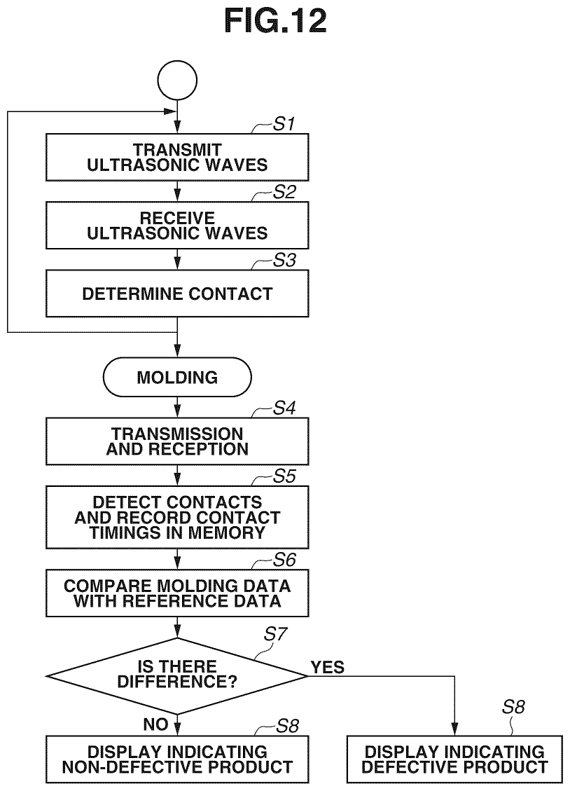

FIG. 9 is a diagram illustrating a configuration for monitoring whether a defect is present in an individual piece, which is being molded, by comparing the molding state of the individual piece being molded with a reference molding state. In FIG. 9, a probe 81 corresponds to the above-described probe 22 or the like. A signal processing apparatus 82 is a control apparatus that includes, for example, a central processing unit (CPU). FIG. 12 is a flowchart illustrating a control procedure that is executed by the signal processing apparatus 82.

In step S1 in FIG. 12, the probe 81 repeatedly transmits and receives ultrasonic waves during a pressing operation in a transfer process. In step S2, the probe 81 for receiving receives a signal in each transmission and reception operation. In step S3, the signal processing apparatus 82 determines whether the mold and the glass are in contact with each other. As described above, the detected signal that changes depending on the contact state of the mold and the glass is used for the contact determination. The detection (S2) and the determination (S3) are repeatedly performed during the pressing operation, and the signal processing apparatus 82 obtains the time at which the state of the glass and the mold has changed from the non-contact state to the contact state at each pre-set ultrasonic wave path position.

In steps S4 and S5, for example, in molding in which a non-defective product has been obtained, the timings at which the state of the glass and the mold changes from the non-contact state to the contact state on N ultrasonic wave paths, that is, contact timings X₁, X₂, . . . , X_{N}, are recorded in advance and stored in a reference data input unit 83 as reference data. A memory such as a read-only memory (ROM) or a random-access memory (RAM) can be used as the reference data input unit 83. Next, in the same manner as described above, contact timings Y₁, Y₂, . . . , Y_{N} on N ultrasonic wave reception paths in the transfer process are recorded in the memory.

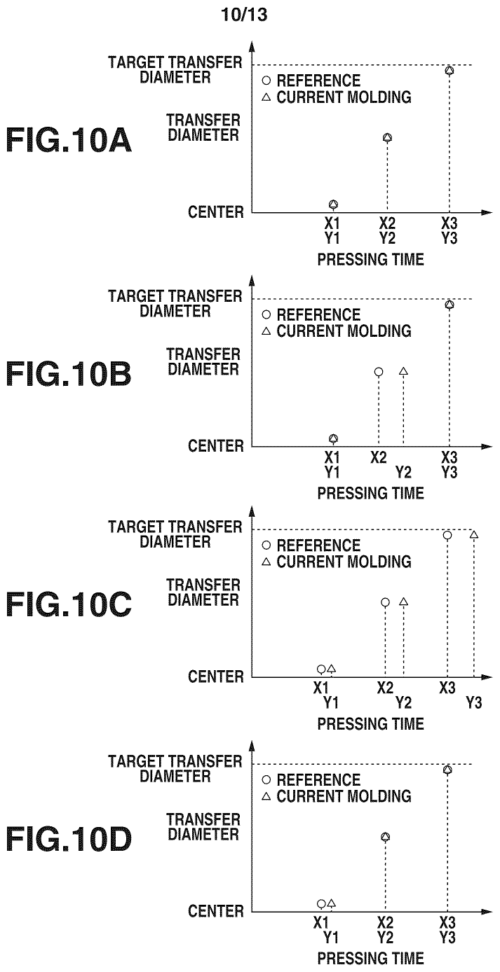

Next, in steps S6 and S7, a comparison unit 84 compares the data of the current molding with the reference data in the reference data input unit 83, and determines whether there is a difference between the data and the reference data. FIGS. 10A and 10B are diagrams illustrating transfer progress in which each contact timing is illustrated in combination with its corresponding transfer diameter. Here, three ultrasonic wave reception paths are set. FIG. 10A illustrates a case where there is no difference between the two values, and thus, it can be determined that no molding defect has occurred in the transfer process.

However, FIG. 10B indicates that there is a difference between the contact timings X₂ and Y₂, and thus, it can be determined that a molding defect has occurred in the transfer process. In this case, in the comparison determination (S7), thresholds may be set for the sum of squared differences between the two values, which is expressed by the following Equation (1), the sum of absolute values of the difference, which is expressed by Equation (2), and the value calculated by the correlative coefficients expressed by Equation (3). However, other calculation methods may be used as long as the methods can compare the differences between the plurality of values. Finally, in step S8, a display unit 85 displays information based on the comparison result obtained by the comparison unit 84.

$$f = {\sum }_{i = 1}^{N} {( {X}_{i} - {Y}_{i} )}^{2} \qquad ( 1 )$$

$$f = {\sum }_{i = 1}^{N} \vert {X}_{i} - {Y}_{i} \vert \qquad ( 2 )$$

$$f = \frac{{\sum }_{i = 1}^{N} {X}_{i} {Y}_{i}}{{\sum }_{i = 1}^{N} {X}_{i} \times {\sum }_{i = 1}^{N} {Y}_{i}} \qquad ( 3 )$$

The comparison unit 84 can be software or the like that is executed by the CPU or the like included in the signal processing apparatus 82. The display unit 85 is a display device including a device, such as a liquid crystal display. The comparison result can be displayed in any format. For example, when the difference between the reference data and the current measurement result is large, the display unit 85 can perform an alarm display to notify the user of the occurrence of a defect. The display unit 85 is not limited to a display unit that performs visual display, and may be a display unit that performs the alarm display based on audio display using a buzzer, synthesized sound, or the like.

As described above, according to the control procedure illustrated in FIG. 12, the current information including a combination of the elapsed time from the start of the molding and the acoustic signal measured by the probe 81 is compared with the reference data including a combination of the elapsed time and the acoustic signal, the reference data having been set in advance in the reference molding. When there is a difference between the current information and the reference data, the display device (the display unit 85) notifies the user of a molding defect. Thus, the user can monitor the transfer progress in molding as the glass conforms to the molding surfaces of the molds, during the molding, and can determine the molding defect during the molding. If a molding defect occurs, the subsequent steps can be canceled. In this way, efficient production can be achieved. The above configuration has a great advantage over the conventional configuration in which the defect cannot be determined until the molds are released.

### [Feedback Control]

Further, for example, by executing feedback control using the reference data of a non-defective product, non-defective products can be produced constantly.

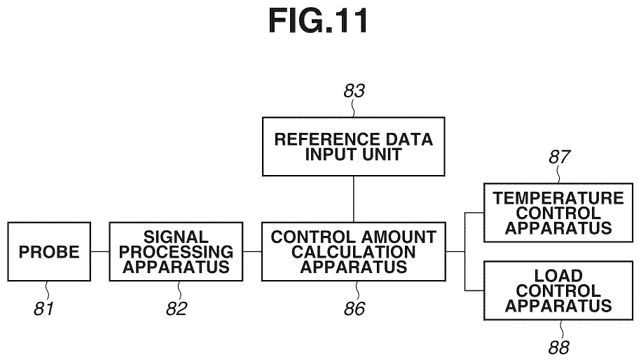

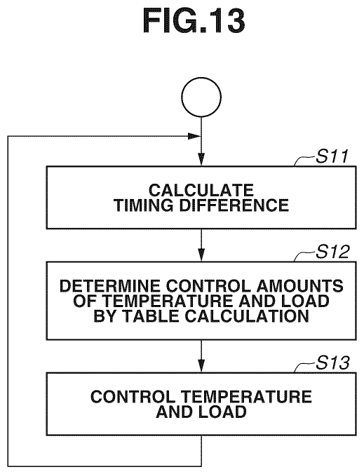

FIG. 11 is a diagram illustrating a configuration of a control system that executes feedback control such that the current molding achieves the same transfer progress as in the reference molding, and FIG. 13 is a flowchart illustrating a control procedure that is performed by this configuration. In FIG. 11, a probe 81 and a reference data input unit 83 are the same as those in FIG. 9. While the signal processing apparatus 82 in FIG. 9 has been described to include a calculation unit such as a CPU, a section for calculating the temperature and the load of the molds in the calculation unit is independently illustrated as a control amount calculation apparatus 86 in FIG. 11.

That is, the control amount calculation apparatus 86 is a control unit for calculating the control amounts of the temperature and the load of the molds such that the contact state between the mold and the glass progresses to be close to that of the reference data in the reference data input unit 83. Specifically, in step S11 in FIG. 13, for example, when the timing Y₁, at which the mold and the glass come into contact with each other, is obtained at the ultrasonic wave path closest to the center, the control amount calculation apparatus 86 calculates the difference (X₁−Y₁) between the contact timing X₁ of the reference molding and the contact timing of the current molding. Next, in step S12, the control amount calculation apparatus 86 obtains the control amounts of the temperature and the load of the molds based on the difference (X₁−Y₁) between the contact timings.

The relationship between the difference and the control amounts of the temperature and the load of the molds is simulated in advance and stored as a table in a memory. The table memory may be interpolated by machine learning.

In step S13, a temperature control apparatus 87 and a load control apparatus 88 operate the molding apparatus based on the control amounts of the temperature and the load of the molds obtained by the control amount calculation apparatus 86. In particular, the temperature control apparatus 87 controls the temperature of the molds via the heaters 4, etc., illustrated in FIG. 1. The load control apparatus 88 controls the load of the molds via a driving unit (not illustrated) such as a solenoid or a motor, which determines the load of the upper mold 11. If the feedback control as described above is not executed, the transfer progress as illustrated in FIG. 10C is obtained. However, when the feedback control as described above is executed, the transfer progress as illustrated in FIG. 10D is obtained, that is, the current molding can match the reference data in most of the transfer progress.

As described above, according to the control procedure in FIG. 13, the molding apparatus compares the current information including a combination of the elapsed time from the start of the molding and the acoustic signal measured by the probe 81 with the reference data including a combination of the elapsed time and the acoustic signal, the reference data having been set in advance in the reference molding. When there is a difference between the current information and the reference data, the molding apparatus causes the control unit to control the load or the temperature of the molds to reduce the difference. Thus, the molding apparatus can monitor the transfer progress in molding as the glass 3 conforms to the molding surfaces of the molds, during the molding, and can execute the transfer process under conditions close to the reference molding indicated by the reference data. In this way, the surface accuracy of the molded product, such as an optical element, can be maintained at a high level.

According to the above embodiments, a molding apparatus that forms a molded product can observe the contact state between molding material and the molding surfaces of the molds, based on acoustic signals at a plurality of positions different from each other in the radial direction between an outer edge and a center of the molding surfaces of the mold. In this way, during molding, the molding apparatus can monitor the transfer progress of the molding as the molding material conforms to the molding surfaces of the molds, through a temporal change in the acoustic signals during the molding.

According to the above embodiments, the probes transmit and receive ultrasonic waves as the acoustic signals. Ultrasonic transmission/reception elements, such as ultrasonic transducers or piezoelectric elements, can be used as the probes.

According to the above embodiments, the probes are disposed at three or more positions different from each other in the radial direction between the outer edge and the center of the molds. Thus, the molding apparatus can detect the acoustic signals at three or more positions different from each other in the radial direction, and can monitor the transfer progress in molding as the mold material conforms to the molding surfaces of the molds, during the molding.

According to the above embodiments, the probes include a probe that transmits ultrasonic signals to a first molding surface of the molds, and a probe that receives ultrasonic signals from a second molding surface located at a position facing the first molding surface. Thus, the molding apparatus can detect the acoustic signals transmitted from the first molding surface to the second molding surface of the molds. In this case, the molding apparatus can clearly monitor the contact state between the molding material and the molding surfaces of the molds, compared with the case of detecting the acoustic signals reflected at the molding surface. Therefore, during molding, the molding apparatus can highly accurately monitor the transfer progress of the molding as the molding material conforms to the molding surfaces of the mold.

According to the above embodiments, since the probes transmit and receive the ultrasonic signals to and from the molding surfaces of the molds via at least one waveguide rod, it is not necessary to dispose the probes that transmit and receive the acoustic signals in the proximity of a high-temperature molding portion. Thus, during molding, the molding apparatus can more stably monitor the transfer progress of the molding as the molding material conforms to the molding surfaces of the molds.

According to the above embodiments, current information that includes a combination of elapsed time from the start of molding and an acoustic signal measured by the probes is compared with reference data that includes a combination of elapsed time and an acoustic signal, the reference data having been set in advance in reference molding. The molding apparatus includes a display device configured to notify a user of a molding defect in a case where there is a difference between the current information and the reference data. In this way, the user can recognize a molding defect in specific molding.

According to the above embodiments, current information that includes a combination of elapsed time from the start of molding and an acoustic signal measured by at least one of the probes is compared with reference data that includes a combination of elapsed time and an acoustic signal, the reference data having been set in advance in reference molding. In a case where there is a difference between the current information and the reference data, the molding apparatus controls the load or the temperature of the molds to reduce the difference.

Thus, when the transfer progress as the molding material conforms to the molding surfaces of the molds deviates from the transfer progress of the reference data corresponding to the elapsed time, the molding apparatus can control the load and the temperature to reduce the deviation. In this way, the molding apparatus can perform approximately the same molding as the reference molding from which the reference data has been acquired.

### Example

A specific example in which an optical element was molded by using the molding apparatus illustrated in FIGS. 1, 2, and 5A will be described below.

The through-transmission mode was used to operate ultrasonic waves. The cylindrical waveguide rods 21 each made of alumina and having a diameter of 5 millimeters (mm) and a length of 150 mm were arranged inside the upper mold 11 made of cemented carbide. The three probes 221, 222, and 223 for transmitting ultrasonic waves having a center frequency of 10 megahertz (MHz) were disposed for ultrasonic transmission. Each interface between the probe and the waveguide rod 21, each interface between the waveguide rod 21 and the upper mold 11, and each interface between the waveguide rod 21 and the lower mold 12 were arranged to be parallel to the transmission/reception surface of each of the probes 221, 222, and 223, and water-glass-based acoustic matching material with high thermal resistance was applied to each interface.

One of the waveguide rods 21 and the probe 221 were disposed at a position corresponding to the central portion of the glass having a post-molding target diameter of 40 mm. Another one of the waveguide rods 21 and the probe 222 were arranged at a position shifted outward by 3 mm. The other one of the waveguide rods 21 and the probe 223 were arranged at a position shifted outward by another 3 mm with the same phase as the probe 222. The waveguide rods 23 and the receiving probes 241, 242, and 243 were arranged inside the lower mold 12 in a similar manner. The waveguide rods 23 and the receiving probes 241, 242, and 243 were arranged to be vertically symmetrical to the waveguide rods 21 and the transmitting probes 221, 222, and 223.

Using the temperatures of the glass and the molds in the transfer process, the sound speed in each material was calculated, and ultrasonic propagation paths were calculated by simulation factoring in refraction. As a result, the arrangement of the ultrasonic wave paths and the outer diameter as illustrated in FIG. 5A was obtained. The transmission and reception of the ultrasonic waves were performed between the paired probes at separate timings. That is, the transmission and reception between the probes 221 and 241, the transmission and reception between the probes 222 and 242, and the transmission and reception between the probes 223 and 243 were performed sequentially in this order, and this series of transmission and reception was repeated. In this operation, the ultrasonic waves were transmitted at intervals of 1 millisecond (msec). For the transmission and reception between the probes, a pulser receiver (not illustrated) or the like was used for driving of the transmitting probes 221, 222, and 223, amplification of signals received by the receiving probes 241, 242, and 243, and analog-digital conversion. When a product, such as a pulser receiver, is used, an ultrasonic transducer that comes with the pulser receiver can be used as the transmitting probes 221 to 223 and the receiving probes 241 to 243.

In the molding operation, first, in a state where the molds were open as illustrated in FIG. 1, the air in the cavity 6 was released and replaced by nitrogen gas. The upper mold 11, the lower mold 12, and the body mold 5 were heated to a predetermined temperature by the heaters 4. The glass 3 was placed with high accuracy at the center of the molding surface 12a of the lower mold 12 by a robotic hand (not illustrated). Next, by using the heaters 4, the temperature of the lower mold 12 and the temperature of the upper mold 11 were separately controlled to be raised to a pressing temperature and maintained.

Next, while transmission and reception of ultrasonic waves were repeated, the lower mold 12 was raised and the upper mold 11 was lowered to their predetermined positions by the drive mechanism (not illustrated), and the shapes of the molding surfaces 11a and 12a were transferred to the glass 3.

In this process, the time at which the lower mold 12 started to be raised and the upper mold 11 started to be lowered was set to zero, and the contact timings X1, X2, and X3 were acquired from the signals of the receiving probes 241, 242, and 243. Next, the process proceeded to a cooling process. The upper mold 11, the lower mold 12, and the body mold 5 were cooled by nitrogen (N₂) gas supplied through an N₂ inlet pipe (not illustrated).

A load was applied again to the upper mold 11 and the lower mold 12 by the driving mechanism (not illustrated), such as a solenoid or a motor, to prevent the glass 3 from being unintentionally separated from the molding surfaces 11a and 12a due to contraction of the glass 3, which was a molded product, before the temperature was lowered to a predetermined temperature by the cooling. The cooling was further continued, and when the temperature reached a predetermined temperature equal to or lower than the glass transition point, the load on the upper mold 11 and the lower mold 12 was released. The cooling was further performed, and when the temperature reached a predetermined temperature, the upper mold 11 was raised and the lower mold 12 was lowered. Next, the molded glass 3 was removed by the robotic hand (not illustrated), and the molding was completed. The molded glass was inspected and it was determined to be a non-defective product. Therefore, it was determined that the detected contact timings X1, X2, and X3 were used as reference data.

Next, another piece of glass was prepared, and the molding was performed in the same manner. When the process proceeded up to the step of transferring the shapes of the molding surfaces 11a and 12a to the glass 3, contact timings Y1, Y2, and Y3 were acquired by transmission and reception of ultrasonic waves. The sum of squared differences between the contact timings Y1, Y2, and Y3 and the contact timings X1, X2, and X3 was calculated by Equation (1). The sum of the squared differences was greater than a predetermined value, and thus, a warning to notify the user of the occurrence of a defect was displayed on a display connected to the molding apparatus. Thus, the glass 3 was rapidly cooled, and when the temperature reached a predetermined temperature, the upper mold 11 was raised and the lower mold 12 was lowered, and the glass 3 was removed by the robotic hand (not illustrated).

Since the molding defect was detected during the molding by using the control system configured as illustrated in FIG. 9, the molding was ended in 15 minutes, and molding of the next piece of glass was started. Without the probes and the control system as illustrated in FIG. 9, the ordinary molding process including the cooling process was performed, which took 59 minutes to complete. Then, the molded glass was inspected, and it was determined to have a transfer defect. As described above, by using the probes and the control system according to the present disclosure, the defect was detected at an early stage, and the production efficiency of the molded product was significantly improved.

According to the present disclosure, it is possible to provide a molding apparatus capable of monitoring a transfer progress in molding as a molding material conforms to a molding surface of a mold, during the molding.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-215059, filed Dec. 10, 2024, which is hereby incorporated by reference herein in its entirety.

What is claimed is:

1. A molding apparatus that manufactures a molded product by bringing molds into pressure contact, the molding apparatus comprising:
a probe configured to transmit and receive an acoustic signal,
wherein the probe is disposed at a plurality of positions different from each other in a radial direction between an outer edge and a center of molding surfaces of the molds.

2. The molding apparatus according to claim 1, wherein the probe is configured to transmit and receive an ultrasonic wave as the acoustic signal.

3. The molding apparatus according to claim 1, wherein the probe is disposed at three or more positions different from each other in the radial direction between the outer edge and the center of the molds.

4. The molding apparatus according to claim 1, wherein the probe includes a first probe for transmitting an ultrasonic signal to a first molding surface of the molds, and a second probe for receiving the ultrasonic signal from a second molding surface facing the first molding surface.

5. The molding apparatus according to claim 1, wherein the probe transmits and receives the acoustic signal to and from the molding surfaces of the molds via a waveguide rod.

6. The molding apparatus according to claim 1, further comprising:
a display device configured to notify a user of a molding defect,
wherein current information including a combination of elapsed time from start of molding and an acoustic signal measured by at least one of the probes is compared with reference data including a combination of elapsed time and an acoustic signal, the reference data having been set in advance by reference molding, and
wherein the display device notifies, in a case where there is a difference between the current information and the reference data, the user of a molding defect.

7. The molding apparatus according to claim 1, further comprising:
a control unit configured to control a load or a temperature of the molds,
wherein current information including a combination of elapsed time from start of molding and an acoustic signal measured by at least one of the probes is compared with reference data including a combination of elapsed time and an acoustic signal, the reference data having been set in advance by reference molding, and
wherein the control unit controls, in a case where there is a difference between the current information and the reference data, the load or the temperature of the molds to reduce the difference.

8. A manufacturing system comprising the molding apparatus according to claim 1.

9. A method for manufacturing a product by performing molding using the molding apparatus according to claim 1.

10. A control method of a molding apparatus that manufactures a molded product by bringing molds into pressure contact, the control method comprising:
acquiring, by a control apparatus, a state of the molded product based on information acquired from a probe that transmits and receives an acoustic signal and is disposed at a plurality of positions different from each other in a radial direction between an outer edge and a center of molding surfaces of the molds.

11. A non-transitory computer-readable recording medium storing a control program executable to perform the control method according to claim 10.
